(19) United States
(12) Patent Application Publication
(10) Pub. No.: US 2017/0357654 A1
(43) Pub. Date: Dec. 14, 2017

(54) USING AUDIO AND VIDEO MATCHING TO DETERMINE AGE OF CONTENT

(71) Applicant: Google Inc., Mountain View, CA (US)

(72) Inventors: Johan Georg Granström, Kilchberg (CH); Matthias Rochus Konrad, Zurich (CH); Oleg Bochkarev, Zurich (CH)

(21) Appl. No.: 15/178,612

(22) Filed: Jun. 10, 2016

(51) Int. Cl. G06F 17/30

(52) U.S. Cl. CPC G06F 17/3079; G06F 17/3082; G06F 17/30825

(57) ABSTRACT

A computer at a content management system receives a first digital content item from a content provider. The computer matches the first digital content item to each of a plurality of reference digital content items in a database. The system determines a plurality of match metrics from the matches. Each match metric is indicative of a similarity between the first digital content item and one of the plurality of reference digital content items. Responsive to one of the match metrics being greater than a threshold level, the system sets a content age of the first digital content item to equal a content age of a reference digital content item associated with the match metric. Responsive to none of the match metrics being greater than the threshold, the system sets the content age of the first digital content item to a time of receiving the first digital content item.

### BACKGROUND

### 1. Technical Field

The application generally relates to audio and video matching technology and search technology, and more specifically to determining content age and ranking videos in search results.

### 2. Description of the Related Art

Electronic video libraries can contain thousands or millions of video files, making delivering relevant and new search results an extremely challenging task. The challenges become particularly significant in the case of online video sharing sites where many users can freely upload video content. In some instances, users upload near-duplicate content items that were previously submitted to a content management system. If the content management system is unable to identify the uploaded content item as near-duplicate content, the content management system may falsely identify the uploaded content item as a newly uploaded content item. While some uploaded content items can be identified by file name or other information provided by the user, this identification information can be incorrect or insufficient to correctly identify the uploaded content item.

One method used to order a list of uploaded content items is by upload date. In this method, the list of uploaded content items is sorted in reverse chronological order based on the date the uploaded content items were created. Often, the upload time or crawl time of the uploaded content items is taken as a proxy for the uploaded content item's creation date, or age, resulting in the promotion of uploaded content items that are re-uploaded.

### SUMMARY

Described embodiments relate to determining age of a digital content item. A computer at a content management system receives a first digital content item from a content provider. The computer matches the first digital content item to each of a plurality of reference digital content items in a database. The content management system determines a plurality of match metrics from the matches. Each match metric is indicative of a similarity between the first digital content item and one of the plurality of reference digital content items. Responsive to one of the match metrics being greater than a threshold level, the content management system sets a content age of the first digital content item to equal a content age of a reference digital content item associated with the match metric. Responsive to none of the match metrics being greater than the threshold, the content management system sets the content age of the first digital content item to a time of receiving the first digital content item.

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

FIG. 1 illustrates a block diagram of an exemplary computing environment that supports a system for determining content age, according to one embodiment.

FIG. 2 illustrates a flow chart of a method for determining content age of a video, according to one embodiment.

FIG. 3 illustrates a flow chart of a method for ranking results based on content age, according to one embodiment.

FIG. 4 illustrates one embodiment of components of an example machine able to read instructions from a machine-readable medium and execute them in a processor (or controller).

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed. Reference will now be made in detail to several embodiments, examples of which are illustrated in the accompanying figures.

### DETAILED DESCRIPTION

### I. Configuration Overview

One embodiment of a disclosed system, method and computer readable storage medium includes determining the content age of a digital content item. Examples of digital content items include audio, video, images, etc. Videos are used as an example; however, the disclosure is not limited to videos.

Embodiments relate to determining a content age of a video. A content management system receives a video from a content provider over a network. The content management system matches the received video with reference videos in a video database. The content management system determines from the matching a plurality of match metrics. Each match metric indicates a similarity between the received video and one of the reference videos. If one of the match metrics is greater than a threshold level, a content age of the received video is set to equal a content age of a reference video associated with that match metric; otherwise, the content age of the received video is set to a time receiving the video.

### II. Computing Environment

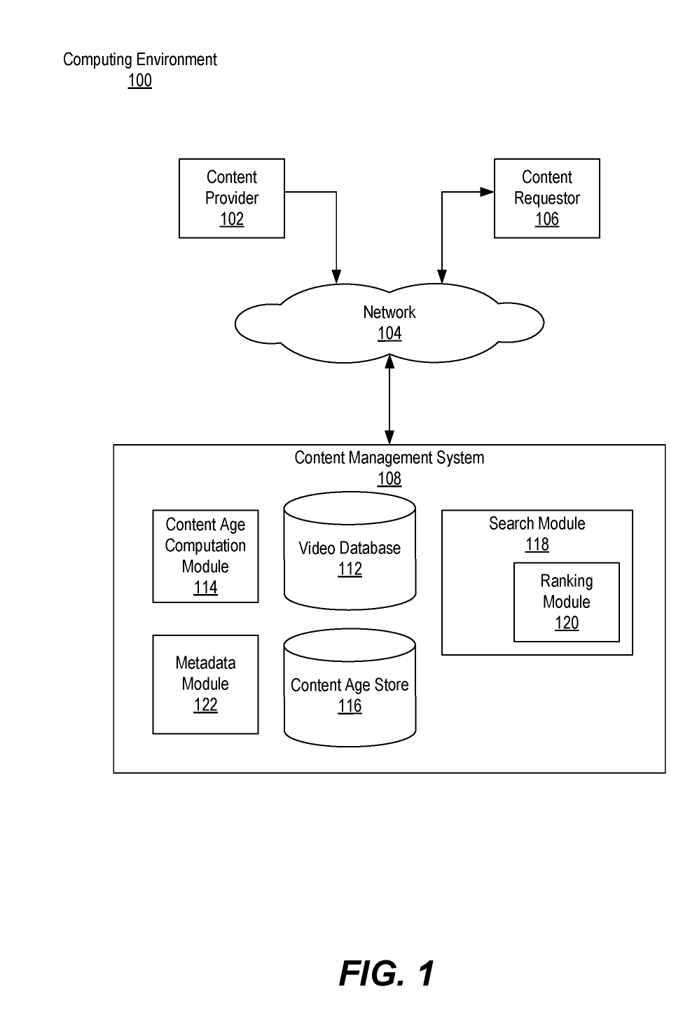

FIG. 1 illustrates a block diagram of a computing environment 100 for determining content age of a digital content item such as a video, according to one embodiment. The computing environment 100 includes a content provider 102, a content management system 108 and a content requestor 106. Each of these entities includes computing devices that can be physically remote from each other but which are communicatively coupled by a network 104. The network 104 is typically the Internet, but can be any network(s), including but not limited to a LAN, a MAN, a WAN, a mobile wired or wireless network, a private network, a virtual private network, or a combination thereof.

The content provider 102 provides a video to the content management system 108 via the network 104. The content provider 102 can include content creators and content distributors. Unlike creators, distributors generally do not create content and instead simply obtain and/or aggregate the content. The video provided by the content provider 102 can include video data, audio data, metadata, etc. The video can be, for example, in a compressed state or an uncompressed state. Only a single content provider 102 is shown, but in practice there are many (e.g., millions) content providers 102 that communicate with and use the content management system 108.

The content requestor 106 sends a request for a list of videos to the content management system 108 via the network 104. In one example, the content requestor 106 is a computing device that executes software instructions in response to client inputs (e.g., a general purpose web browser or a dedicated application). The content requestor 106 can be, for example, a personal computer, a laptop, a personal digital assistant, a cellular, mobile, or smart phone, a set-top box or any other network enabled consumer electronic (“CE”) device. The request for the list of videos can include any identifiers for a video including, but not limited to, search terms, topics, captions, locations, content provider, etc.

The content management system 108 receives a video from the content provider 102 and determines a content age of the received video based on match metrics indicative of similarity between the received video and each of a plurality of reference videos stored at the content management system 108. For example, videos can be considered similar if video fingerprints, audio fingerprints, metadata tags, duration, thumbnail previews, etc. of the videos, or portions thereof, are the same or similar (i.e., vary slightly). The content management system 108 further outputs a list of videos to the content requestor 106 responsive to a request from the content requestor 106. The content management system 108 receives a request from the content requestor 106, determines a list of reference videos matching the request, ranks the list of reference videos based on content age of the reference videos, and sends the ranked list to the content requestor 106.

### III. Content Management System

The content management system 108 receives a video from the content provider 102 via the network 104 and determines a content age of the received video. Furthermore, the content management system 108 receives a request from the content requestor 106 via the network 104, determines a list of reference videos matching the request, ranks the list of reference videos based on content age of the reference videos, and sends the ranked list to the content requestor 106.

The content management system 108 includes a video database 112, a content age computation module 114, a content age store 116, a search module 118, and a metadata module 122.

The video database 112 stores a plurality of reference videos, each reference video including video data, audio data, metadata, etc. The video database 112 is coupled to the network 104 and can be implemented as any device or combination of devices capable of persistently storing data in computer readable storage media, such as a hard disk drive, RAM, a writable compact (CD) or DVD, a solid-state memory device, or other optical/magnetic storage mediums. Other types of computer-readable storage mediums can be used, and it is expected that as new storage mediums are developed in the future, they can be configured in accordance with the teachings here.

The metadata module 122 generates metadata for the received video and for each video of the plurality of reference videos in the video database 112. In some embodiments, the metadata module 122 generates metadata pertaining to the entire video. In other embodiments, the metadata module 122 generates metadata pertaining to the entire video as well as indexed metadata pertaining to specific time segments of the video. The metadata can include operational metadata and user-authored metadata. Examples of operational metadata include, for example, equipment used (camera, lens, accessories, etc.), software employed, creation date, GPS coordinates, etc. Examples of user-authored metadata include, for example, title, author, keyword tags, description, actor information, etc. The metadata generated by the metadata module 122 can be stored in the video database 112 along with the associated reference video.

The content age computation module 114 matches the received video to each of the plurality of reference videos in the video database 112, determines match metrics, and sets a content age of the received video. In one embodiment, the content age computation module 114 time segments the received video and matches each of the time segments of the received video to time segments of each of the plurality of reference videos in the video database 112.

In matching the received video to each of the plurality of reference videos in the video database 112, the content age computation module 114 compares the video data, audio data, etc. of the received video to the video data, audio data, etc. of each of the plurality of reference videos in the video database 112 using traditional video and audio matching methods. The content age computation module 114 can further compare the metadata of the received video to the metadata of each of the plurality of reference videos. In one embodiment, the content age computation module 114 generates a match list including reference videos having video data, audio data, metadata, etc., that match that of the received video.

The content age computation module 114 then determines from the matching a plurality of match metrics. Each match metric is indicative of a similarity between the received video and one of the plurality of reference videos in the video database 112. In one embodiment, each match metric is indicative of a similarity between the received video and one of the plurality of videos in the match list. Each match metric can represent a match percentage between the received video and one of the plurality of reference videos in the video database 112. The match percentage represents a likelihood the received video matches the reference video in the match list.

As noted above, in one embodiment, the content age computation module 114 time segments the received video and matches each of the time segments of the received video to time segments of each of the plurality of reference videos in the video database 112. In this embodiment, each match metric is indicative of a similarity between each time segment of the received video and each time segment of each reference video. The content age computation module 114 further determines an aggregate match metric between the received video and each of the reference videos in the match list based on each match metric between each time segment of the received video and each time segment of each reference video.

In some embodiments, the content age computation module 114 associates different weights to the match metrics for the various time segments of the received video. By associating different weights to the match metrics, the content age computation module 114 can determine a more accurate aggregate match metric. In some embodiments, the opening and closing segments of the received video can be weighted lower (i.e., down-weighted) than middle segments of the video because, for example, the opening and closing segments of the received video can be similar to opening and closing segments of a subset of the plurality of reference videos. For example, the opening and closing segments of a plurality of episodes of a television series can be the same or similar. As such, the content age computation module 114 can weigh the opening and closing segments of the plurality of episodes of the television series lower than middle segments of the of the plurality of episodes.

If one of the match metrics is greater than a threshold level, the content age computation module 114 sets the content age of the received video to equal the content age of a reference video with the match metric using the content age of the reference video stored in the content age store 116. That is, since a threshold level of content from the received video is also in the reference video, the received video is at least as old as the reference video.

If more than one of the match metrics is greater than the threshold level, the content age computation module 114 sets the content age of the received video to equal the content age of a reference video with an oldest content age using the content age of the reference video stored in the content age store 116.

If none of the match metrics are greater than the threshold level, the content age computation module 114 sets the content age of the received video to a time the content management system 108 received the video from the content provider 102 (i.e., the upload time). In some embodiments, responsive to none of the match metrics being greater than the threshold level, the content age computation module 114 sets the content age of the received video to a time in the metadata that indicates the content age of the received video, for example, as specified by operational metadata and/or user-authored metadata.

In one embodiment, the content age computation module 114 adjusts the threshold level for certain content providers 102. For example, the threshold level for a news agency can be set to a high value, such as 99%. News agencies constantly upload videos to the content management system 108 and many of the uploaded videos include footage that are similar to existing videos previously uploaded to the content management system 108 by the news agency such as, for example, file footage. Accordingly, even though the videos received from the news agency by the content management system 108 can have a match metrics greater than a threshold level less than the adjusted threshold level, the content age computation module 114 sets the content age of the received videos to a time the content management system 108 received the videos from the news agency. For example, a news agency can upload a first video about a current event including ground footage of the event. Later in the day the news agency can upload a second video recapping the previous event and include the same ground footage included in the first video. In this example, the match metric can be high (e.g., 90%). With a high adjusted threshold level (e.g., 99%), the content age computation module 114 determines the content age of the second video is equal to a time the content management system 108 received the second video as opposed falsely setting the content age of the second video to equal to the content age of the first video.

The content age computation module 114 sets the content age of the received video, stores the content age in the content age store 116 and stores the received video in the video database 112 thus adding to the plurality of reference videos.

The search module 118 processes a request from a content requestor 106 for a list of videos. The search module 118 generates a search list including reference videos stored in the video database 112 matching a search criteria. A ranking module 120 ranks the search list according to the content age stored in the content age store 116 associated with each of the videos of the search list to generate a freshness list. The freshness list ranks the search list by content age (e.g., “newest” to “oldest”) based on the content age of each video, thereby promoting new content instead of promoting all newly uploaded video irrelevant of similar content previously received by the content management system 108.

### IV. Determining Content Age

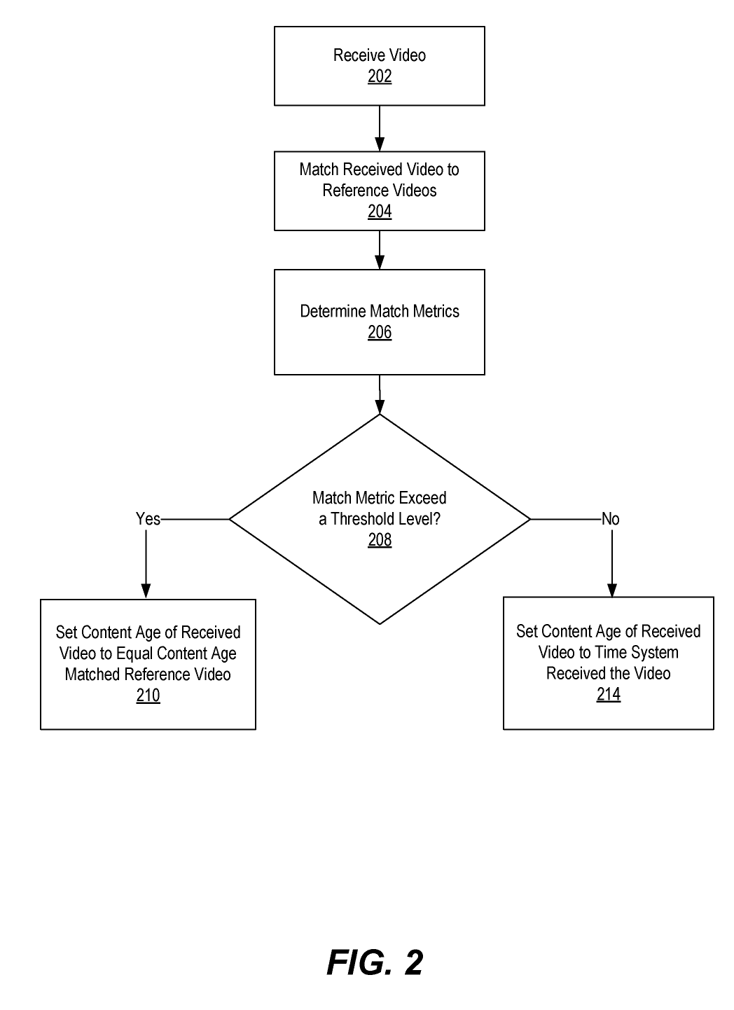

FIG. 2 is a flow chart illustrating a method for determining content age of a video, according to one embodiment. The content management system 108 receives 202 a video from content provider 102. The content age computation module 114 matches 204 the received video to each of a plurality of reference videos in the video database 112.

The content age computation module 114 determines 206 from the matching a plurality of match metrics, each match metric indicative of a similarity between the received video and one of the plurality of reference videos in the video database 112.

If the match metric is greater than 208 a threshold level, the content age computation module 114 sets 210 the content age of the received video to equal a content age of a reference video associated with that match metric. For example, if the received video, a newly uploaded video, has an 85% match with a reference video in video database 112, a previously uploaded video, the content age computation module 114 sets a content age of the received video to the content age of the reference video since 85% of the received video matches the reference video and 85% is greater than a threshold level of 70%.

If match metric is not greater than 208 a threshold level, the content age computation module 114 sets 214 the content age of the received video to a time the content management system 108 received the video. Continuing with the example, if the received video has a 30% match with the reference video, the content age computation module 114 sets a content age of the received video to a time the content management system 108 received the video.

### V. Ranking Videos

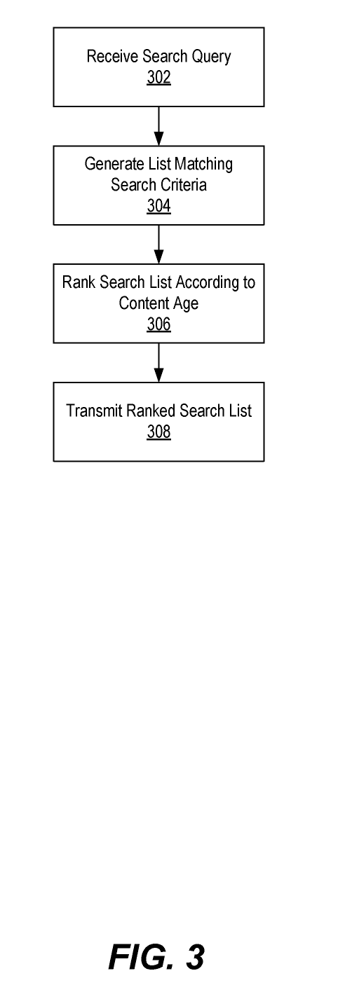

FIG. 3 is a flow chart illustrating a method for ranking results based on content age, according to one embodiment. The search module 118 receives 302 a search query from the content requestor 106, the search query including a request for a list of videos matching a search criteria. The search module 118 generates 304 a search list including reference videos stored in the video database 112 matching the search criteria. The ranking module 120 ranks 306 the reference videos in the search list according to the content age stored in the content age store 116 and associated with each of the reference videos of the search list to generate a ranked list. The ranked list includes the reference videos in the search list organized based on the content age of each video in the search list. The ranked list ranks new content more highly instead of falsely ranking all newly uploaded video content irrelevant of similar content previously received. The search module 118 transmits 308 the ranked search list to the content requestor 106.

### VI. Computing Machine Architecture

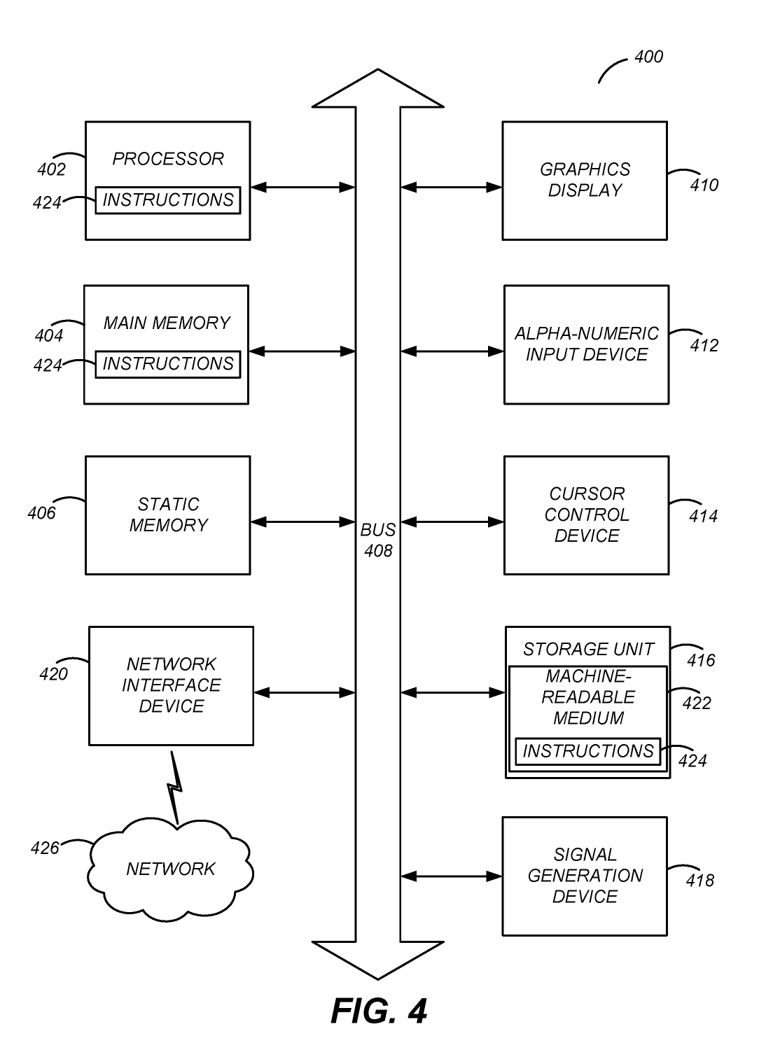

FIG. 4 is a block diagram illustrating components of an example computing device 400 able to read instructions from a machine-readable medium and execute them in a processor (or controller) for implementing the system and performing the associated methods described above. The computing device may be any computing device capable of executing instructions 424 (sequential or otherwise) that specify actions to be taken by that machine. Further, while only a computing device is illustrated, the term “computing device” shall also be taken to include any collection of computing devices that individually or jointly execute instructions 524 to perform any one or more of the methodologies discussed herein.

The example computing device 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computing device 400 may further include graphics display unit 410 (e.g., a plasma display panel (PDP), an organic light emitting diode (OLED) display, a liquid crystal display (LCD), a projector, or a cathode ray tube (CRT)) and corresponding display drivers. The computing device 400 may also include alphanumeric input device 412 (e.g., a keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computing device 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### VII. Additional Configuration Considerations

Certain embodiments are described herein as including logic or a number of components, modules, or mechanisms, for example, as illustrated in FIG. 1. Modules may constitute either software modules (e.g., code embodied on a machine-readable medium) or hardware modules. A hardware module is tangible unit capable of performing certain operations and may be configured or arranged in a certain manner. In example embodiments, one or more computing devices may include one or more hardware modules for implementing the operations described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The hardware or software modules may also operate to support performance of the relevant operations in a “cloud computing” environment or as a “software as a service” (SaaS). For example, at least some of the operations may be performed by a group of computing devices, these operations being accessible via a network (e.g., the Internet) and via one or more appropriate interfaces (e.g., application program interfaces (APIs)). The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative designs for a system and a process for determining content age and promoting videos based on content age through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for determining age of a content item, the method comprising:
receiving, by a computer at a content management system, a first digital content item from a content provider;
matching, by the computer, the first digital content item to each of a plurality of reference digital content items in a database;
determining from the matching a plurality of match metrics, each match metric indicative of a similarity between the first digital content item and one of the plurality of reference digital content items;
responsive to one of the match metrics being greater than a threshold level, setting a content age of the first digital content item to equal a content age of the reference digital content item associated with that match metric; and
responsive to none of the match metrics being greater than the threshold level, setting the content age of the first digital content item to a time of receiving the first digital content item.

2. The method of claim 1, wherein matching, by the computer, the first digital content item to each of the plurality of reference digital content items in the database comprises:
comparing video data and audio data of the received video to video data and audio data of each of the plurality of reference digital content items in the database.

3. The method of claim 2, wherein matching, by the computer, the first digital content item to each of the plurality of reference digital content items in the database further comprises:
comparing metadata of the first digital content item to metadata of each of the plurality of reference digital content items in the database.

4. The method of claim 1, further comprising:
segmenting the first digital content item into a plurality of time segments; and
wherein determining the match metrics further comprises:
matching each time segment of the first digital content item to each time segment of each of the plurality of reference digital content items.

5. The method of claim 4, wherein each match metric is indicative of a similarity between each time segment of the first digital content item and each time segment of each of the plurality of reference digital content items.

6. The method of claim 5, wherein determining from the matching the plurality of match metrics further comprises:
determining an aggregate match metric indicative of a similarity between time segments of the first digital content item and time segments of a reference digital content item.

7. The method of claim 4, wherein each match metric for each of the plurality of segments has an associated weight.

8. The method of claim 7, further comprising:
down-weighting at least one of a first time segment and a last time segment of the plurality of time segments of the first digital content item.

9. The method of claim 1, further comprising:
responsive to two or more match metrics being greater than the threshold level, setting the content age of the of the first digital content item to equal a content age of a reference digital content item associated with a match metric of the two or more match metrics with an oldest content age.

10. The method of claim 1, wherein determining from the matching the plurality of match metrics further comprises:
determining match percentages, each match percentage indicative of a likelihood the first digital content item matches one of the plurality of reference digital content items.

11. The method of claim 1, further comprising:
responsive to none of the match metrics being greater than the threshold level, setting the content age of the first digital content item to a time indicated in metadata of the first digital content item.

12. The method of claim 1, wherein the first digital content item is a video, and wherein the plurality of reference digital content items are videos.

13. A system comprising:
a non-transitory computer-readable storage medium storing executable computer instructions that, when executed, perform steps comprising:
receiving, by a computer at a content management system, a first digital content item from a content provider;
matching, by the computer, the first digital content item to each of a plurality of reference digital content items in a database;
determining from the matching a plurality of match metrics, each match metric indicative of a similarity between the first digital content item and one of the plurality of reference digital content items;
responsive to one of the match metrics being greater than a threshold level, setting a content age of the first digital content item to equal a content age of the reference digital content item associated with that match metric; and
responsive to none of the match metrics being greater than the threshold level, setting the content age of the first digital content item to a time of receiving the first digital content item; and
a processor configured to execute the computer instructions.

14. The system of claim 13, wherein the instructions that, when executed, perform steps comprising matching further comprises instructions that, when executed, perform steps comprising:
comparing video data and audio data of the received video to video data and audio data of each of the plurality of reference digital content items in the database.

15. The system of claim 14, wherein the instructions that, when executed, perform steps comprising matching further comprises instructions that, when executed, perform steps comprising:
comparing metadata of the first digital content item to metadata of each of the plurality of reference digital content items in the database.

16. The system of claim 13, wherein the instructions that, when executed, further perform steps comprising:
segmenting the first digital content item into a plurality of time segments; and
wherein the instructions that, when executed, perform steps comprising determining the match metrics further comprises instructions that, when executed, perform steps comprising:
matching each time segment of the first digital content item to each time segment of each of the plurality of reference digital content items.

17. The system of claim 16, wherein each match metric is indicative of a similarity between each time segment of the first digital content item and each time segment of each of the plurality of reference digital content items.

18. The system of claim 17, wherein the instructions that, when executed, perform steps comprising determining from the matching the plurality of match metrics comprises instructions that, when executed, perform steps comprising:
determining an aggregate match metric indicative of a similarity between time segments of the first digital content item and time segments of a reference digital content item.

19. The system of claim 16, wherein each match metric for each of the plurality of segments has an associated weight.

20. The system of claim 19, wherein the instructions that, when executed, further perform steps comprising:
down-weighting at least one of a first time segment and a last time segment of the plurality of time segments of the first digital content item.

21. The system of claim 13, wherein the instructions that, when executed, further perform steps comprising:
responsive to two or more match metrics being greater than the threshold level, setting the content age of the of the first digital content item to equal a content age of a reference digital content item associated with a match metric of the two or more match metrics with an oldest content age.

22. The system of claim 13, wherein the instructions that, when executed, perform steps comprising determining from the matching the plurality of match metrics comprises instructions that, when executed, perform steps comprising:
determining match percentages, each match percentage indicative of a likelihood the first digital content item matches one of the plurality of reference digital content items.

23. The system of claim 13, wherein the instructions that, when executed, further perform steps comprising:
responsive to none of the match metrics being greater than the threshold level, setting the content age of the first digital content item to a time indicated in metadata of the first digital content item.

24. The system of claim 13, wherein the first digital content item is a video, and wherein the plurality of reference digital content items are videos.
